(19) United States
(12) Patent Application Publication
(10) Pub. No.: US 2004/0064662 A1
(43) Pub. Date: Apr. 1, 2004

(54) Methods and apparatus for bus control in digital signal processors

(75) Inventors: Moinul I. Syed, Austin, TX (US); Michael S. Allen, Austin, TX (US)

Correspondence Address: William R. McClellan, Wolf, Greenfield & Sacks, P.C., 600 Atlantic Avenue, Boston, MA, 02210, US

(73) Assignee: Analog Devices, Inc., Norwood, MA (US)

(21) Appl. No.: 10/255,975

(22) Filed: Sep. 26, 2002

(51) Int. Cl. G06F 12/00

(52) U.S. Cl. 711/169; 711/158

(57) ABSTRACT

A bus interface unit is provided for a digital signal processor including a core processor, a memory and two or more system buses for transfer of data to and from system components. The bus interface unit includes a first bus controller for receiving processor transfer requests from the core processor on two or more processor buses and for directing the processor transfer requests to the memory on a first memory bus. The bus interface further includes a second bus controller for receiving system transfer requests from the system components on the two or more system buses and for directing the system transfer requests to the memory on a second memory bus. The bus controllers may have pipelined architectures and may be configured to service transfer requests independently.

### FIELD OF THE INVENTION

This invention relates to digital processing systems and, more particularly, to methods and apparatus for controlling access to memory on multiple buses. The bus control methods and apparatus are particularly useful in digital signal processors, but are not limited to such applications.

### BACKGROUND OF INVENTION

A digital signal computer, or digital signal processor (DSP), is a special purpose computer that is designed to optimize performance for digital signal processing applications, such as, for example, fast Fourier transforms, digital filters, image processing, signal processing in wireless systems, and speech recognition. Digital signal processor applications are typically characterized by real time operation, high interrupt rates and intensive numeric computations. In addition, digital signal processor applications tend to be intensive in memory access operations and to require the input and output of large quantities of data. Digital signal processor architectures are typically optimized for performing such computations efficiently.

Digital signal processors may include components such as a core processor, memory, a DMA controller, an external bus interface, and a serial port interface on a single chip or substrate. The components of the digital signal processor are interconnected by a bus architecture which produces high performance under desired operating conditions. As used herein, the term “bus” refers to a multiple conductor transmission channel which may be used to carry data of any type (e.g., operands or instructions), addresses and/or control signals. Typically, multiple buses are used to permit the simultaneous transfer of large quantities of data between the components of the digital signal processor. The bus architecture may be configured to provide data to the core processor at a rate sufficient to minimize core processor stalling.

Because digital signal processor computations tend to be intensive in memory access operations, circuits for controlling the transfer of data to and between the core processor, memory and other system components on buses are important elements of high performance digital signal processors. Accordingly, there is a need for improved methods and apparatus for bus control in digital signal processors.

### SUMMARY OF THE INVENTION

According to a first aspect of the invention, a digital signal processor is provided. The digital signal processor comprises a core processor for executing instructions, a memory having a memory bus for transfer of data, and a bus controller for directing transfer requests to the memory on the memory bus. The bus controller, the memory bus and the memory have a pipeline for supplying data in response to the transfer requests. The pipeline has a pipeline depth that is equal to or greater than a memory latency in clock cycles. In one embodiment, the pipeline has a pipeline depth of six stages.

According to another aspect of the invention, a bus interface unit is provided for a digital signal processor including a core processor, a memory and two or more system buses for transfer of data to and from system components. The bus interface unit comprises a first bus controller for receiving processor transfer requests from the core processor on two or more processor buses and for directing the processor transfer requests to the memory on a first memory bus, and a second bus controller for receiving system transfer requests from the system components on the two or more system buses and for directing the system transfer requests to the memory on a second memory bus.

According to another aspect of the invention, a digital signal processor is provided. The digital signal processor comprises a core processor for executing instructions, the core processor having two or more processor buses for transfer of data, a memory having a first memory bus and a second memory bus, two or more system buses for transfer of data to and from system components, and a bus interface unit. The bus interface unit includes a first bus controller for directing transfer requests on the two or more processor buses to the first memory bus and a second bus controller for directing system transfer requests on the two or more system buses to the second memory bus.

The memory may have two or more independently-accessible memory banks. Transfer requests on the first memory bus and the second memory bus can be serviced simultaneously when different memory banks are accessed.

The first bus controller and the second bus controller may each have a pipeline. The first bus controller may be configured to complete one read transfer request per clock cycle after an initial latency. The first bus controller may be configured to direct to the memory, on the first memory bus, processor transfer requests from two processor data buses and one processor instruction bus.

The first bus controller and the second bus controller may each include an arbiter for directing transfer requests to the memory according to assigned priorities. The first bus controller and the second bus controller may each be configured for processing single word transfer requests and burst mode transfer requests.

In some embodiments, the first memory bus and the second memory bus operate at a core clock frequency and the system bus operates at a system clock frequency that is lower than the core clock frequency. The second memory bus controller may include clock conversion circuitry for converting to and between the core clock frequency and the system clock frequency.

According to a further aspect of the invention, a method is provided for accessing memory in a digital signal processor including a core processor, a memory and two or more system buses for transfer of data to and from system components. The method comprises receiving processor transfer requests from the core processor on two or more processor buses and directing the processor transfer requests to the memory on a first memory bus; and receiving system transfer requests from the system components on the two or more system buses and directing the system transfer requests to the memory on a second memory bus.

According to a further aspect of the invention, a memory system comprises a memory, a memory bus coupled to the memory and a bus controller for directing transfer requests to the memory on the memory bus. The bus controller, the memory bus and the memory have a pipeline for supplying data in response to the transfer requests. The pipeline has a pipeline depth that is equal to or greater than a memory latency in clock cycles. The pipeline permits the bus controller to complete one read transfer request per clock cycle after an initial memory latency.

### BRIEF DESCRIPTION OF THE DRAWINGS

For a better understanding of the present invention, reference is made to the accompanying drawings, which are incorporated herein by reference and in which:

FIG. 1 is a block diagram of a digital signal processor in accordance with an embodiment of the invention;

FIG. 2 is a block diagram of a memory architecture in the digital signal processor embodiment of FIG. 1;

FIGS. 3A and 3B are examples of internal and external memory maps, respectively, of the digital signal processor embodiment of FIG. 1;

FIG. 4 is an example of a level 2 (L2) memory map of the digital signal processor embodiment of FIG. 1;

FIG. 5 is a schematic diagram that illustrates an example of bus routing in the system bus interface unit of FIG. 1;

FIG. 6 is a block diagram of the system bus interface unit of FIG. 1;

FIG. 7A is a timing diagram of a memory read pipeline in accordance with an embodiment of the invention;

FIG. 7B is a schematic diagram of a part of the memory read pipeline shown in FIG. 7A;

FIG. 8 is a timing diagram of a memory write pipeline in accordance with an embodiment of the invention;

FIG. 9 is a block diagram of a first bus controller in the system bus interface unit of FIG. 6;

FIG. 10 shows examples of signal waveforms involved in a single read transfer on the first memory bus;

FIG. 11 shows examples of signal waveforms involved in a single write transfer on the first memory bus;

FIG. 12 shows examples of signal waveforms involved in a burst read transfer on the first memory bus;

FIG. 13 shows examples of signal waveforms involved in back-to-back read transfers on the first memory bus;

FIG. 14 is a block diagram of a second bus controller in the system bus interface unit of FIG. 6;

FIG. 15 shows examples of signal waveforms involved in a single read transfer on the second memory bus;

FIG. 16 shows examples of signal waveforms involved in a single write transfer on the second memory bus;

FIGS. 17A-17D are timing diagrams that illustrate core clock domain to system clock domain conversion waveforms for clock ratios of 2:1, 2.5:1, 3:1 and 4:1, respectively;

FIGS. 18A-18D are timing diagrams that illustrate system clock domain to core clock domain conversion waveforms for clock ratios of 2:1, 2.5:1, 3:1 and 4:1, respectively;

FIG. 19 is a block diagram of an embodiment of circuitry for generating core and system clocks and synchronization signals for clock domain conversion; and

FIG. 20 is a schematic diagram of an embodiment of circuitry for clock domain conversion.

### DETAILED DESCRIPTION

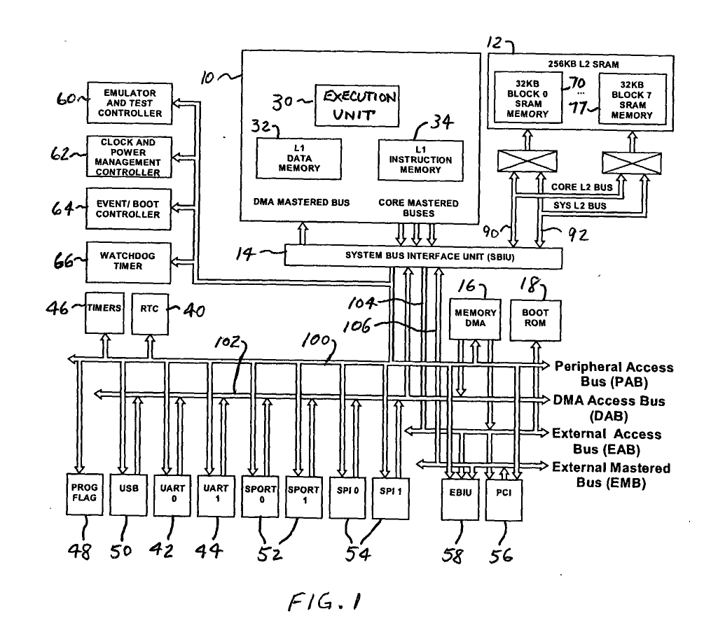

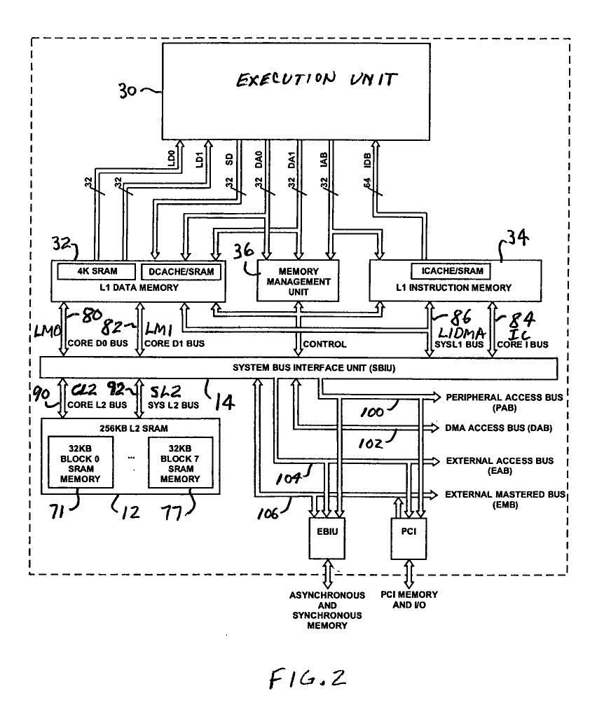

A digital signal processor in accordance with an embodiment of the invention is shown in FIGS. 1-4. The digital signal processor (DSP) includes a core processor 10, a level two (L2) memory 12, a system bus interface unit (SBIU) 14, a DMA controller 16 and a boot ROM 18. Core processor 10 includes an execution unit 30, a level one (L1) data memory 32, an L1 instruction memory 34 and a memory management unit 36 (see FIG. 2). In some embodiments, L1 data memory 32 may be configured as SRAM or as data cache and L1 instruction memory 34 may be configured as SRAM or as instruction cache. In one embodiment, L1 data memory 32 includes 32K bytes of data SRAM/cache and 4K bytes of data scratchpad SRAM, and L1 instruction memory 34 includes 16K bytes of instruction SRAM/cache. The DSP may further include real-time clock 40, UART port 42, UART port 44, timers 46, programmable flags 48, USB interface 50, serial ports 52, SPI ports 54, PCI bus interface 56 and external bus interface unit 58. The DSP may also include an emulator and test controller 60, a clock and power management controller 62, an event/boot controller 64 and a watchdog timer 66.

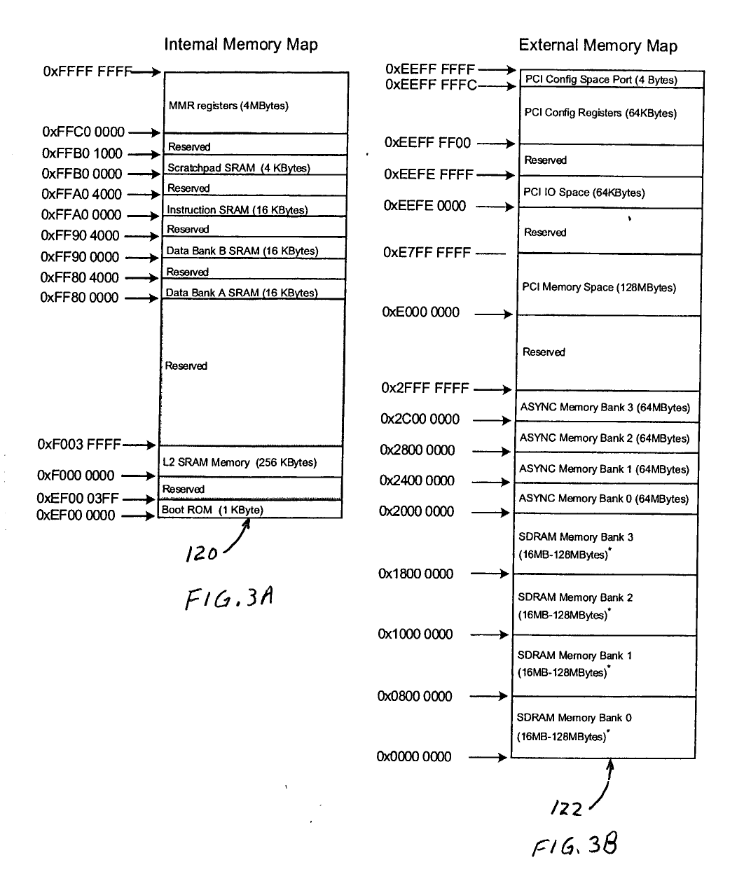

An example of a memory map of the digital signal processor is shown in FIGS. 3A and 3B. An internal memory map 120 is shown in FIG. 3A, and an external memory map 122 is shown in FIG. 3B. An upper portion of the internal memory space is allocated to the core processor 10 and system memory management registers. The on-chip L2 memory 12 is allocated to the lower portion of internal memory space. External memory map 122 includes PCI memory space, PCI I/O space and PCI configuration space. In addition, four banks are available for SDRAM. Each bank may vary in size from 16 megabytes to 128 megabytes. An additional four banks of asynchronous memory space, each of 64 megabytes, are also available.

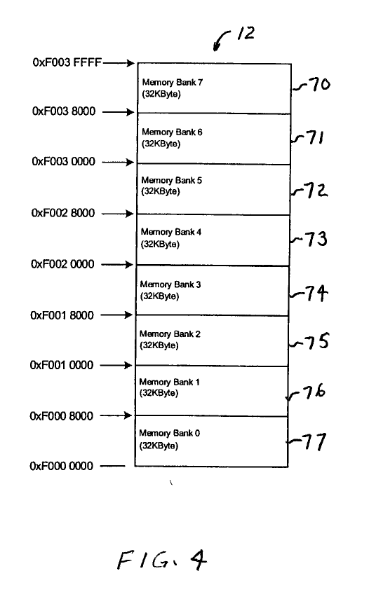

The L2 memory map is expanded in FIG. 4. L2 memory 12 may be organized in blocks. In the embodiment of FIGS. 1-4, L2 memory 12 has a capacity of 256 kilobytes and is organized as eight blocks 70, 71, . . . 77 of 32 kilobytes each. Blocks 70, 71, . . . 77 are independently accessible.

System bus interface unit 14 is connected to core processor 10 by processor buses, which may include an LM0 bus 80, an LM1 bus 82 and an IC bus 84 (FIG. 2). LM0 bus 80 and LM1 bus 82 are connected to L1 data memory 32 and carry data between SBIU 14 and L1 data memory 32. IC bus 84 is connected to L1 instruction memory 34 and carries instructions between SBIU 14 and L1 instruction memory 34. System bus interface unit 14 is also connected to core processor 10 by an LIDMA bus 86. L1DMA bus 86 is connected to L1 data memory 32 and L1 instruction memory 34 and permits DMA transfers to and from L1 memories 32 and 34. System bus interface unit 14 is connected to L2 memory 12 by a first memory bus, CL2 bus 90, and a second memory bus, SL2 bus 92. As described below, CL2 bus 90 handles memory access requests from core processor 10, and SL2 bus 92 handles memory access requests from other components of the system. System buses, which may include a PAB bus 100, a DAB bus 102, an EAB bus 104 and an EMB bus 106, are connected between system bus interface unit 14 and other components of the digital signal processor.

The system bus interface unit 14 performs bus bridging functions in the digital signal processor. It functions as a crossbar switch, routing requests from the core processor 10, the PCI bus interface 56 and the DMA controller 16 to the appropriate destinations, such as L1 memories 32 and 34, L2 memory 12 and external memory via external bus interface unit 58. For example, the SBIU 14 provides parallel and concurrent data transfer capability between the core processor 10 and the system controllers where possible. To provide these functionalities, the SBIU 14 acts as a slave port to the requesting master, then arbitrates the master request for an appropriate bus and manages the bus transfer to complete the master request. In addition, the SBIU 14 performs clock domain conversion between the core processor 10 and the rest of the digital signal processor for various system clock to core clock ratios.

The SBIU 14 interfaces with the core processor 10 through four buses, LM0 bus 80, LM1 bus 82, IC bus 84 and L1DMA bus 86. Core processor 10 sends load/store requests to SBIU 14 through LM0 bus 80 and LM1 bus 82. The IC bus 84 is used by core processor 10 to fetch instructions. The L1DMA bus 86 is a slave port to core processor 10 and is used by the different DMA engines in the digital signal processor to move data directly into L1 data memory 32 or L1 instruction memory 34.

The SBIU 14 interfaces with the on-chip L2 memory 12 through CL2 bus 90 and SL2 bus 92. The SBIU 14 routes all transfer requests from core processor 10 on LM0 bus 80, LM1 bus 82 and IC bus 84 to the L2 memory 12. The CL2 bus 90 is dedicated to core processor 10 only and is designed to meet the high bandwidth requirements of the core processor 10. The CL2 bus 90 is fully pipelined and may include six pipeline stages for read transfers; it supports both single and burst transfers. The CL2 bus 90 has a 64-bit datapath and runs at the core processor frequency.

Components of the digital signal processor other than core processor 10 access L2 memory 12 through SL2 bus 92. The SBIU 14 identifies all transfer requests from DAB bus 102 and EMB bus 106, arbitrates the requests and routes them to L2 memory 12 on SL2 bus 92. The SL2 bus 92 is designed to meet relatively lower bandwidth requirements from the system, since the system runs at slower clock frequency than core processor 10. The SBIU 14 converts the slower clock domain signals of the system buses to the core clock domain before sending them to L2 memory 12.

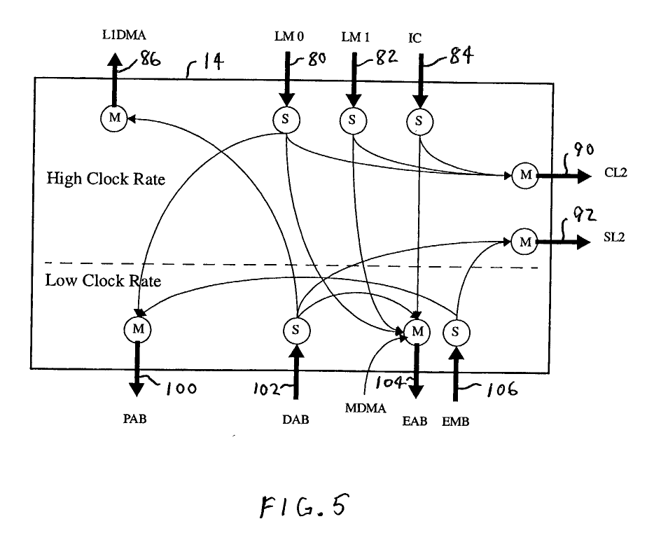

FIG. 5 is a schematic diagram that shows how buses are routed to appropriate destinations by SBIU 14. In FIG. 5, each arrow represents a transfer request, “M” represents a bus for which SBIU 14 operates as a master, and “S” represents a bus for which SBIU 14 operates as a slave. Thus, for example, FIG. 5 indicates that transfer requests on LM0 bus 80, LM1 bus 82 and IC bus 84 are routed to L2 memory 12 via CL2 bus 90. Transfer requests on DAB bus 102 and EMB bus 106 are routed to L2 memory 12 via SL2 bus 92. FIG. 5 further indicates that LM0 bus 80, LM1 bus 82, IC bus 84, L1DMA bus 86, CL2 bus 90 and SL2 bus 92 operate at the relatively high frequency of the core clock, whereas PAB bus 100, DAB bus 102, EAB bus 104 and EMB bus 106 operate at the relatively low frequency of the system clock. The core clock domain and the system clock domain within SBIU 14 have a synchronous relationship. The system clock may operate at a selectable clock ratio of 2:1, 2.5:1, 3:1 or 4:1 with respect to the core clock, with the core clock having a higher frequency.

The SBIU 14 may include a power save function. When SBIU 14 determines that no transfer requests are being serviced, a power save signal is sent to L2 memory 12. When the power save signal is asserted, the clock to L2 memory 12 may be gated off, thereby reducing the power required by digital signal processor.

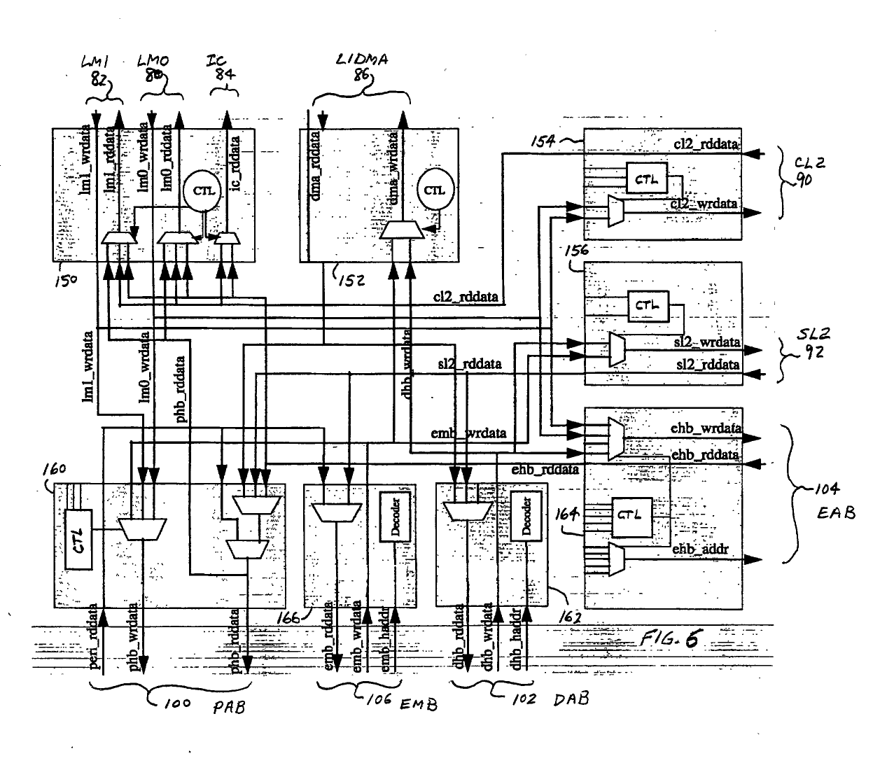

A simplified block diagram of SBIU 14 is shown in FIG. 6. SBIU 14 includes a core bus controller 150 for controlling LM0 bus 80, LM1 bus 82 and IC bus 84, and an L1DMA bus controller 152 for controlling L1DMA bus 86.

SBIU 14 further includes a first bus controller, CL2 bus controller 154, for controlling CL2 bus 90 and a second bus controller, SL2 bus controller 156, for controlling SL2 bus 92. Further, SBIU 14 includes a PAB bus controller 160 for controlling PAB bus 100, a DAB bus controller 162 for controlling DAB lo bus 102, an EAB bus controller 164 for controlling EAB bus 104 and an EMB bus controller 166 for controlling EMB bus 106. In general, each bus except IC bus 84 includes a read datapath and a write datapath. IC bus 84 does not include a write datapath because there is no requirement for core processor 10 to write instructions to any destination. In general, each bus controller includes control logic and a data selector for selecting a source of write data or a source of read data. For example, CL2 bus controller 154 may select write data from LM0 bus 80 or LM1 bus 82. SL2 bus controller 156 may select write data from DAB bus 102 or EMB bus 106. The CL2 bus controller 154 and the SL2 bus controller 156 are described in further detail below.

The CL2 bus controller 154 and the CL2 bus 90 may have a pipelined architecture to achieve high performance. The CL2 bus 90 is dedicated to transfer requests from core processor 10. The transfer requests are received on LM0 bus 80, LM1 bus 82 and IC bus 84. The CL2 bus controller 154 arbitrates core processor 10 requests and then initiates and controls bus cycles on CL2 bus 90. The CL2 bus 90 operates at the core clock frequency and supports single and burst mode transfers. The CL2 bus 90 may have a 64-bit wide datapath to support byte, half word, word and double word data transfers.

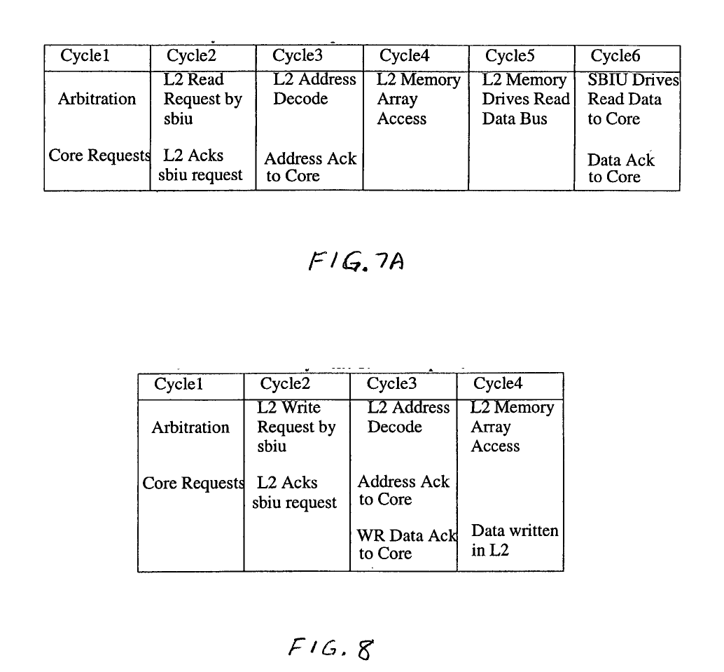

The pipeline operation for a memory read transfer is shown in FIG. 7A. The pipeline has a depth of six cycles, including five cycles for the CL2 bus and an additional cycle to send the read data from SBIU 14 to core processor 10. Thus, a read request has a latency of six cycles from the request to the first cycle of read data at the core processor interface. Referring to FIG. 7A, in cycle 1, core processor 10 requests a memory read transfer, and SBIU 14 performs arbitration of the request. In cycle 2, SBIU 14 issues a read request to L2 memory 12, and L2 memory 12 acknowledges the SBIU request. In cycle 3, L2 memory 12 performs address decoding, and SBIU 14 sends an address 1o acknowledge to core processor 10. In cycle 4, L2 memory 12 accesses the memory array, and in cycle 5, L2 memory 12 drives the read data bus. In cycle 6, SBIU 14 drives the read data to core processor 10 and sends a data acknowledge to core processor 10.

A portion of the pipeline is shown schematically in FIG. 7B. One pipeline stage corresponds to each of the cycles shown in FIG. 7A. SBIU 14 includes a first pipeline stage (not shown) for receiving core processor transfer requests. A register 170 represents a second pipeline stage and corresponds to cycle 2 shown in FIG. 7A. Decoders 174 and registers 175 represent a third pipeline stage and correspond to cycle 3 shown in FIG. 7A. Memory banks 70, 71, . . . 77 and registers 176 represent a fourth pipeline stage and correspond to cycle 4 shown in FIG. 7A. A 64-bit data selector 178, a register 180, a 32-bit data selector 182 and a register 184 represent a fifth pipeline stage and correspond to cycle 5 shown in FIG. 7A. SBIU 14 includes a sixth pipeline stage (not shown) for supplying read data to core processor 10.

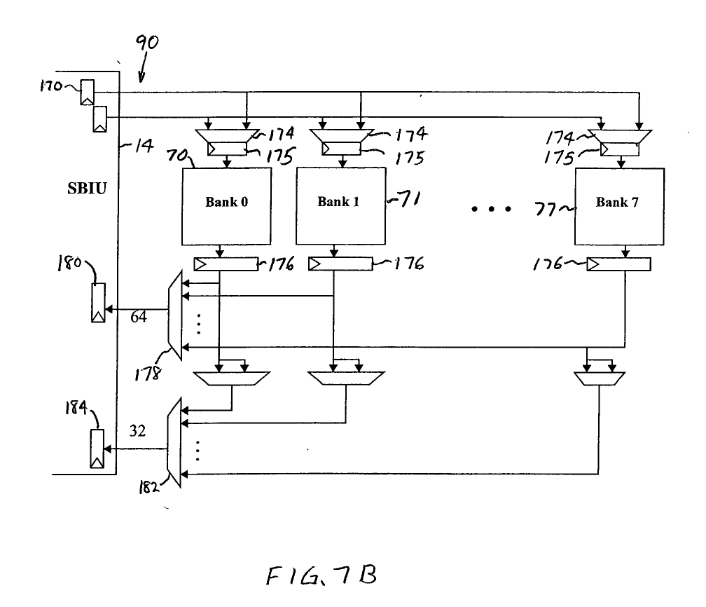

The pipeline operation for a memory write transfer is illustrated in FIG. 8. In cycle 1, core processor 10 requests a memory write transfer, and SBIU 14 performs arbitration of the request. In cycle 2, SBIU 14 issues a write request to L2 memory 12, and L2 memory 12 acknowledges the SBIU request. In cycle 3, L2 memory 12 performs address decoding, and SBIU 14 sends an-address acknowledge and a data acknowledge to core processor 10. In cycle 4, the L2 memory array is accessed and data is written in L2 memory 12.

The memory read transfer pipeline shown in FIGS. 7A and 7B and described above has a latency of six cycles and a throughput of one cycle. Thus, the first request in a series of consecutive read transfer requests has a latency of six cycles, and the following requests have a latency of one cycle. This operation may be represented as latencies of 6-1-1-1 clock cycles. The read transfer requests may originate on LM0 bus 80, LM1 bus 82 or IC bus 84. Each read transfer request may be a single read transfer request or a burst read transfer request. The read transfer request in the CL2 bus pipeline may originate from the same or different core processor buses, and the six cycle latency is incurred only with respect to the first memory read transfer request in a series of consecutive requests. Furthermore, a requestor such as LM0 bus 80 can send a second request before receiving all data from a first request.

The depth of the pipeline affects the performance in servicing transfer requests. In particular, a pipeline having an insufficient number of stages results in stall cycles, also known as “bubbles”, between data words in the case of back-to-back transfer requests. In order to avoid stall cycles, the pipeline depth in stages should be equal to or greater than the latency in servicing a single read transfer request. Using this approach, the first read transfer request has the specified latency, whereas read transfer requests following the first have a latency of one clock cycle.

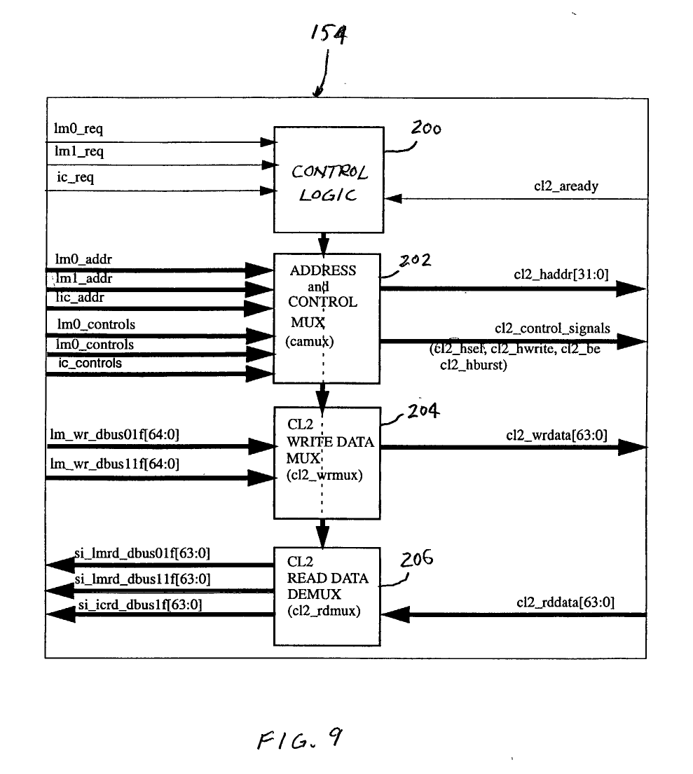

A block diagram of an embodiment of CL2 bus controller 154 is shown in FIG. 9. Control logic 200 includes an arbiter that arbitrates among transfer requests on LM0 bus 80, LM1 bus 82 and IC bus 84. In one embodiment, LM0 bus 80 has highest priority, LM1 bus 82 has second highest priority and IC bus 84 has lowest priority. It will be understood that different priorities may be utilized. An address and control multiplexer 202 selects the appropriate address and control signals according to the output of control logic 200. A write data multiplexer 204 selects the appropriate write data signals according to the output of control logic 200 in the case of a write data transfer. A read data demultiplexer 206 directs read data from L2 memory 12 to the appropriate destination in accordance with the output of control logic 200 in the case of a read data transfer.

As shown in FIG. 9, LM0 bus 80, LM1 bus 82 and CL2 bus 90 each have an address bus, a read data bus and a write data bus. IC bus 84 includes an 1o address bus and a read data bus. This configuration allows overlapping of read transfers and write transfers, since the separate read and write data buses can be driven in the same clock cycle.

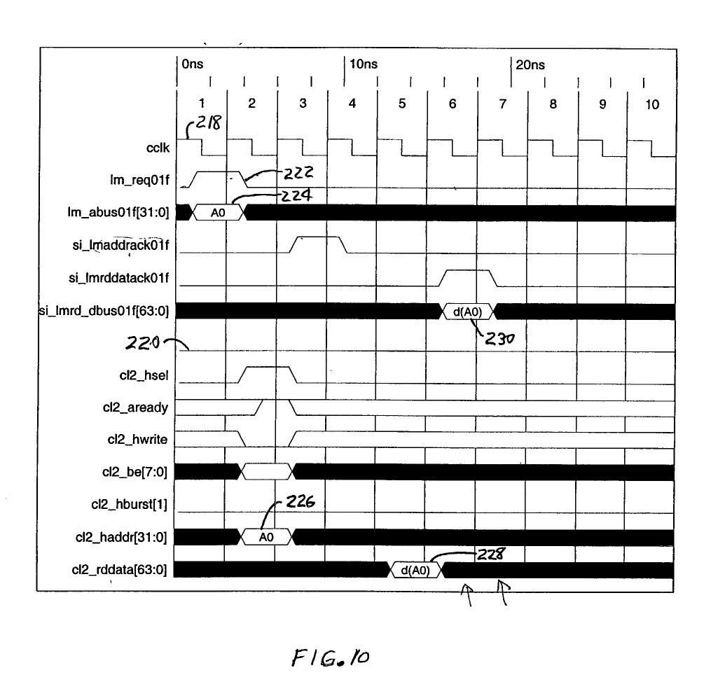

Signals associated with a single read transfer request by core processor 10 are shown in FIG. 10. Waveforms above line 220 in FIG. 10 represent signals on LM0 bus 80, and waveforms below line 220 represent signals on CL2 bus 90. A transfer request 222 and an address 224 are asserted by core processor 10 on LM0 bus 80 in clock cycle 1 of a core clock 218. The SBIU 14 issues an address 226 on CL2 bus 90 in clock cycle 2. The read data 228 is returned by L2 memory 12 on the read data lines of CL2 bus 90 in clock cycle 5, and the read data 230, which corresponds to read data 228, is supplied to core processor 10 on the read data lines of LM0 bus 80 in clock cycle 6.

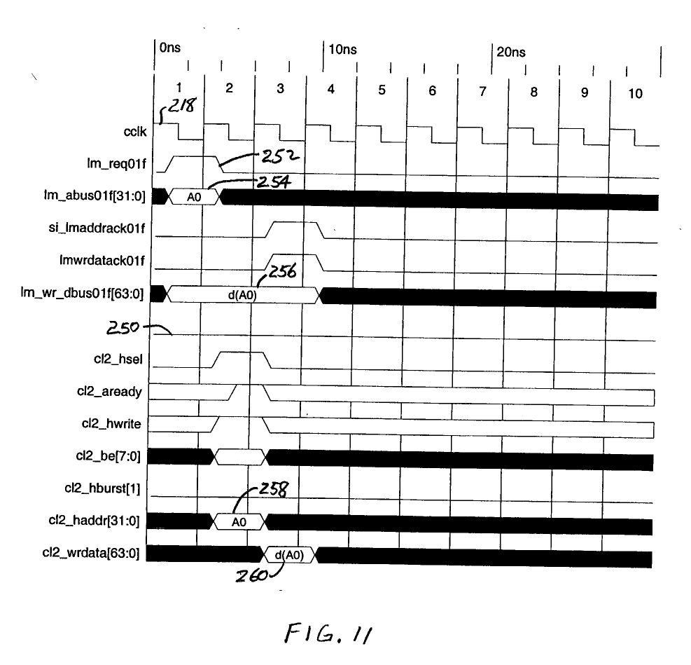

Signals associated with a single write transfer request by core processor 10 are shown in FIG. 11. Waveforms above line 250 in FIG. 11 represent signals on LM0 bus 80, and waveforms below line 250 represent signals on CL2 bus 90. A transfer request 252 and an address 254 are asserted by core processor 10 on LM0 bus 80 in clock cycle 1 of core clock 218. The write data 256 is present on LM0 bus 80 in clock cycles 1-3. The SBIU 14 issues an address 258 on CL2 bus 90 in clock cycle 2. The write data 260, which corresponds to write data 256, is supplied on the write data lines of CL2 bus 90 in clock cycle 3 and is written to the specified address in L2 memory 12.

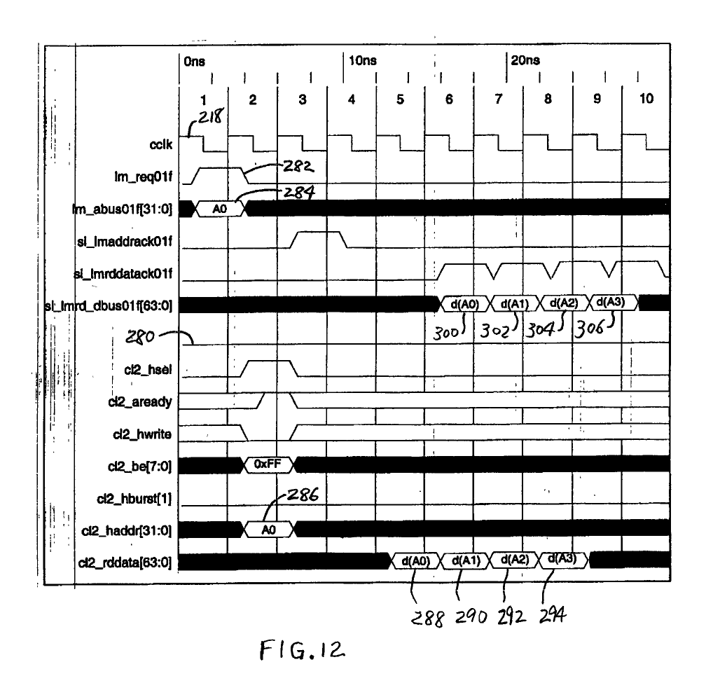

Signals associated with a burst read transfer request by core processor 10 are shown in FIG. 12. Waveforms above line 280 in FIG. 12 represent signals on LM0 bus 80, and waveforms below line 280 represent signals on CL2 bus 90. A transfer request 282 and an address 284 are asserted by core processor 10 on LM0 bus 80 in clock cycle 1 of core clock 218. The SBIU 14 issues an address 286 on CL2 bus 90 in clock cycle 2. The first read data word 288 is returned by L2 memory 12 on the read data lines of CL2 bus 90 in clock cycle 5. Read data words 290, 292 and 294 are returned by L2 memory 12 on the read data lines of CL2 bus 90 in clock cycles 6, 7 and 8, respectively. Read data words 300, 302, 304 and 306, which correspond to read data words 288, 290, 292 and 294, respectively, are supplied to core processor 10 on LM0 bus 80 in clock cycles 6, 7, 8 and 9, respectively. Thus, the four data words of the burst have latencies of 6-1-1-1 clock cycles.

Read transfer requests on LM0 bus 80 are illustrated in FIGS. 10 and 12. In normal operation of the digital signal processor, core processor 10 may issue read transfer requests simultaneously on LM0 bus 80, LM1 bus 82 and IC bus 84. The read transfer requests on LM0 bus 80, LM1 bus 82 and IC bus 84 are combined on CL2 bus 90 in a interleaved manner. Because of the pipelined architecture of CL2 bus 90, a read transfer request may be started on each clock cycle, and a read transfer request may be completed on each clock cycle.

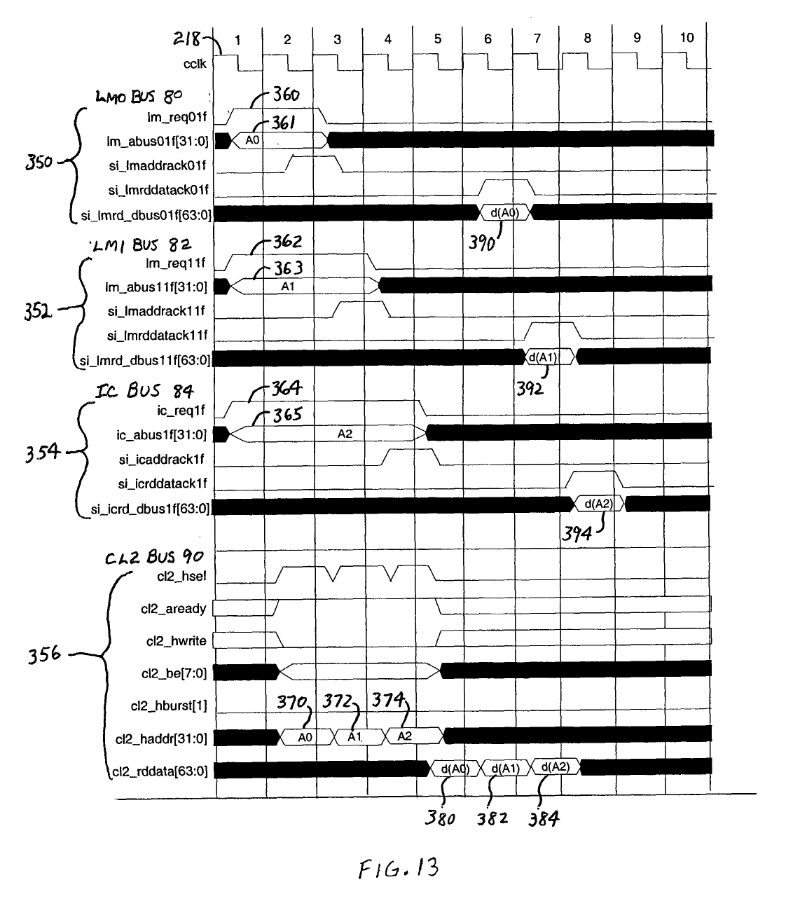

Signals associated with back-to-back read transfer requests by core processor 10 are shown in FIG. 13. Waveforms 350 in FIG. 13 represent signals on LM0 bus 80, waveforms 352 represent signals on LM1 bus 82 and waveforms 354 represent signals on IC bus 84. Waveforms 356 in FIG. 13 represent signals on CL2 bus 90. A transfer request 360 and an address 361 are asserted by core processor 10 on LM0 bus 80 in clock cycle 1 of core clock 218. Similarly, a transfer request 362 and an address 363 are asserted by core processor 10 on LM1 bus 82 in clock cycle 1, and a transfer request 364 and an address 365 are asserted by core processor 10 on IC bus 84 in clock cycle 1. SBIU 14 issues an address 370 on CL2 bus 90 in clock cycle 2, an address 372 in clock cycle 3 and an address 374 in clock cycle 4. According to the priorities described above, addresses 370, 372 and 374 correspond to addresses 361, 363 and 365, respectively. Read data words 380, 382 and 384 are returned by L2 memory 12 on the read data lines of CL2 bus 90 in clock cycles 5, 6 and 7, respectively. Read data words 380, 382 and 384 correspond to addresses 370, lo 372 and 374, respectively. Read data word 390, which corresponds to read data word 380, is supplied to core processor 10 on LM0 bus 80 in clock cycle 6. Read data word 392, which corresponds to read data word 382, is supplied to core processor 10 on LM1 bus 82 in clock cycle 7. Read data word 394, which corresponds to read data word 384, is supplied to core processor 10 on IC bus is 84 in clock cycle 8. Thus, the simultaneously requested data words are supplied to core processor 10 on successive clock cycles without stall cycles, also known as “bubbles”, between data words. The latencies for the three data words are 6-1-1 clock cycles. If requested, additional data words may be supplied to core processor 10 on successive clock cycles.

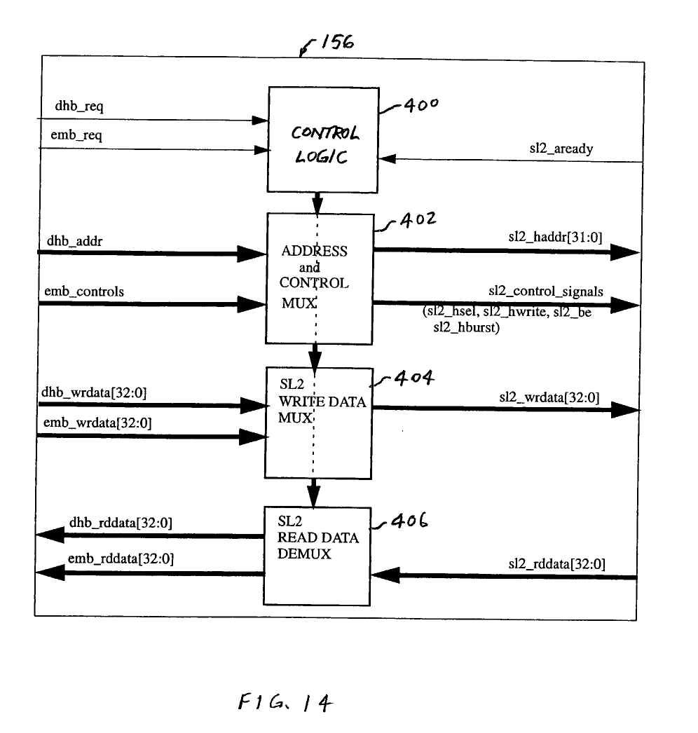

A block diagram of an embodiment of SL2 bus controller 156 is shown in FIG. 14. Control logic 400 includes an arbiter that arbitrates between transfer requests on EMB bus 106 and DAB bus 102. An address and control multiplexer 402 selects the appropriate address and control signals according to the output of control logic 400. A write data multiplexer 404 selects the appropriate write data signals according to the output of control logic 400 in the case of a write data transfer. A read data demultiplexer 406 directs read data from L2 memory 12 to the appropriate destination in accordance with the output of control logic 400 in the case of a read data transfer. The SL2 bus controller 156 has a pipelined architecture as described above in connection with CL2 bus controller 154. In addition, SL2 bus controller 156 performs clock domain conversion between the core clock domain and the system clock domain, as described below. EMB bus 106 and DAB bus 102 operate at the system clock frequency, whereas SL2 bus 92 operates at the core clock frequency.

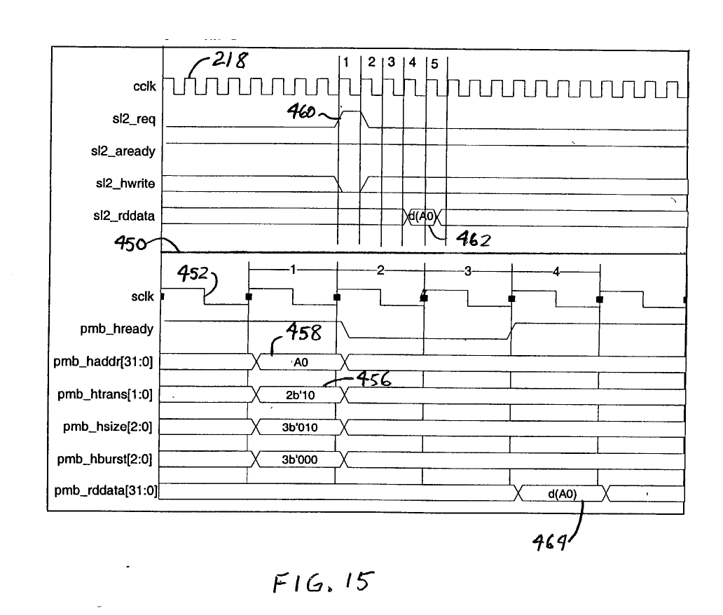

Signals associated with a single read transfer request on EMB bus 106 are shown in FIG. 15. Waveforms below line 450 in FIG. 15 represent signals on EMB bus 106, and waveforms above line 450 represent signals on SL2 bus 92. The EMB bus 106 uses a system clock 452, and the SL2 bus 92 uses the core lo clock 218. As shown, the system clock 454 has a lower frequency than the core clock 218. A transfer request 456 and an address 458 are asserted on EMB bus 106 in clock cycle 1 of system clock 452. The SBIU 14 issues a request 460 on SL2 bus 92 in clock cycle 1 of core clock 218 and receives the read data from L2 memory 12 on the read data lines of SL2 bus 92 in clock cycle 5 of core is clock 218. The read data 464, which corresponds to read data 462, is supplied on the read data lines of EMB bus 106 in clock cycle 4 of system clock 452.

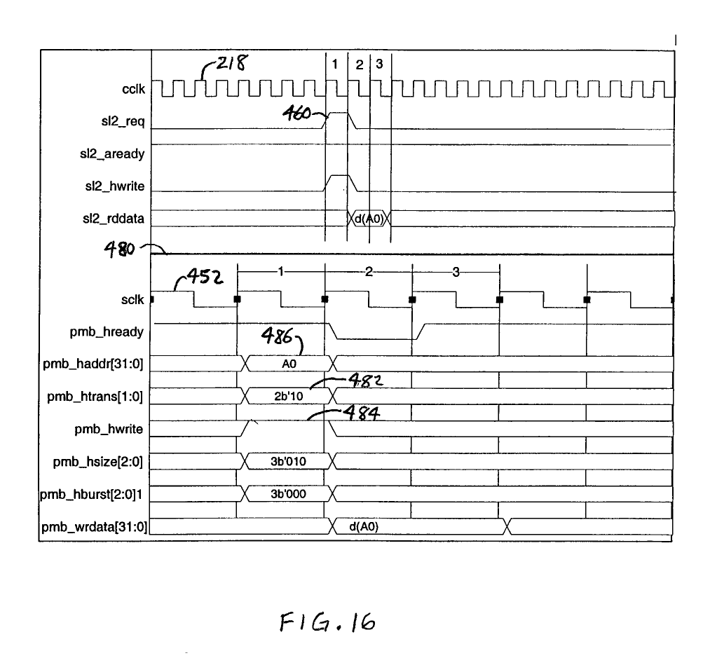

Signals associated with a single write transfer request on EMB bus 106 are shown in FIG. 16. Waveforms below line 480 in FIG. 16 represent signals on EMB bus 106, and waveforms above line 480 represent signals on SL2 bus 92. As described above, EMB bus 106 operates at the frequency of system clock 452, and SL2 bus 92 operates at the frequency of core clock 218. An EMB bus transfer request 482, a write signal 484 and a write address 486 are asserted on EMB bus 106 in clock cycle 1 of system clock 452. The SBIU 14 issues a request 490 on SL2 bus 92 in clock cycle 1 of core clock 218, which corresponds to clock cycle 2 of system clock 452. The write data is asserted on EMB bus 106 in clock cycle 2 of system clock 452, and the data is written to L2 memory 12 on the write data lines of SL2 bus 92 in clock cycle 3 of core clock 218. As shown, clock cycle 3 of core clock 218 occurs within clock cycle 2 of system clock 452. Thus, the write transfer is completed in two cycles of system clock 452.

As noted above, L2 memory 12 may be organized in blocks which are independently accessible. In the example of FIGS. 1-4, L2 memory 12 includes 8 blocks 70, 71, . . . 77. This memory architecture permits CL2 bus 90 and SL2 bus 92 to simultaneously access different blocks in CL2 memory 12. Thus, core processor 10 may be reading or writing data in one block of L2 memory 12 via CL2 bus 90 at the same time that a system component is reading or writing data in another block of L2 memory block via SL2 bus 92.

As noted above, SL2 bus controller 156 performs clock domain conversion between the core clock domain and the system clock domain. As shown in FIG. 5, core processor 10, L2 memory 12, LM0 bus 80, LM1 bus 82, IC bus 84, L1DMA bus 86, CL2 bus 90 and SL2 bus 92 operate at the higher core clock frequency. The remaining components of the digital signal processor, including PAB bus 100, DAB bus 102, EAB bus 104 and EMB bus 106, operate at the lower system clock frequency. Components that operate at the core clock frequency define a core clock domain, and components that operate at the system clock frequency define a system clock domain. The SBIU 14 is required to transfer signals between the core clock domain and the system clock domain, while avoiding latencies that can have an adverse effect on performance. The core clock domain and the system clock domain have a synchronous relationship. In one embodiment, a ratio between the core clock frequency and the system clock frequency is selectable. In one example, a clock ratio of 2:1, 2.5:1, 3:1 or 4:1 may be selected. In one specific example, the selected ratio is 3:1, the core clock frequency is 300 mHz and the system clock frequency is 100 mHz.

To minimize the latency of transfers between clock domains, some of the control functions are performed before the transfer between clock domains. This is achieved by using the core clock and a synchronization signal. An SCLK_SYNC synchronization signal is used for transfers from the core clock domain to the system clock domain. When asserted, the SCLK_SYNC synchronization signal indicates that the next rising edge of the core clock will line up with the next rising edge of the system clock. An ACK_EN synchronization signal is used for transfers from the system clock domain to the core clock domain. When asserted, the ACK_EN synchronization signal indicates that the next rising edge of the core clock is the first edge after the latest rising edge of the system clock.

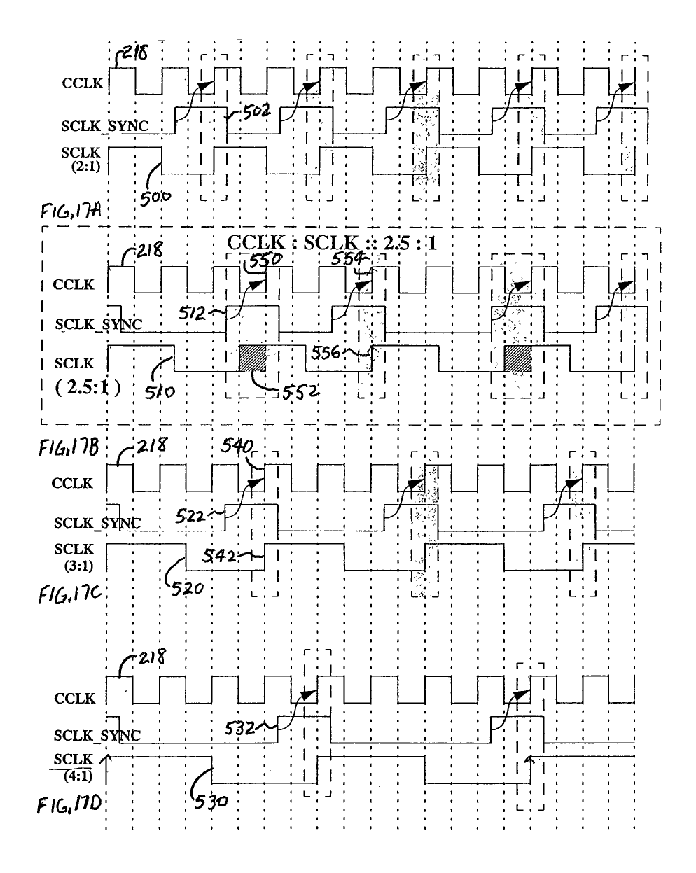

Signals associated with conversion from the core clock domain to the system clock domain for different clock ratios are shown in FIGS. 17A-17D. The system clock may be generated by dividing the frequency of the core clock. In another approach, the core clock and the system clock are generated by dividing a reference clock, using different divider ratios. In FIG. 17A, core clock 218 and a system clock 500 have a clock ratio of 2:1. In FIG. 17B, core clock 218 and a system clock 510 have a clock ratio of 2.5:1. In FIG. 17C, core clock 218 and a system clock 520 have a clock ratio of 3:1. In FIG. 17D, core clock 218 and a system clock 530 have a clock ratio of 4:1. Thus FIGS. 17A, 17C and 17D illustrate integer clock ratios. SCLK_SYNC synchronization signals 502, 512, 522 and 532 are utilized to synchronize clock domain conversion. Each SCLK_SYNC synchronization signal has the same frequency as the system clock and is phased so as to be asserted (logic high in this example), during a core clock cycle when the system clock has a rising edge. The SCLK_SYNC synchronization signal may be asserted for one core clock cycle per system clock cycle. The next core clock rising edge, which occurs during the period when the SCLK_SYNC synchronization signal is asserted, is aligned with a rising edge of the system clock (except in the case of a non-integer clock ratio, such as 2.5:1), and that core clock edge is used to transfer signals from the core clock domain to the system clock domain. Thus, for example, with reference to FIG. 17C, rising edge 540 of core clock 218 occurs when synchronization signal 522 is asserted and rising edge 540 is aligned with a rising edge 542 of system clock 520. Rising edge 540 of core clock 218 may be used to transfer signals from the core clock domain to the system clock domain as described below.

In the special case of a non-integer clock ratio, such as 2.5:1, the system clock edges do not all align with core clock edges. With reference to FIG. 17B, it may be observed that every other system clock rising edge aligns with a core clock rising edge. Using the synchronization technique described above, every other system clock cycle is effectively reduced by ½ core clock cycle. Referring again to FIG. 17B, core clock rising edge 550 is the first core clock rising edge after synchronization signal 512 is asserted. Rising edge 550 is not aligned with a rising edge of system clock 510, and a shaded portion 552 of system clock 510 is effectively lost. Rising edge 550 of core clock 218 may be used to transfer signals from the core clock domain to the system clock domain. Alternate system clock rising edges are aligned with core clock rising edges. Thus, for example, core clock rising edge 554 is aligned with system clock rising edge 556.

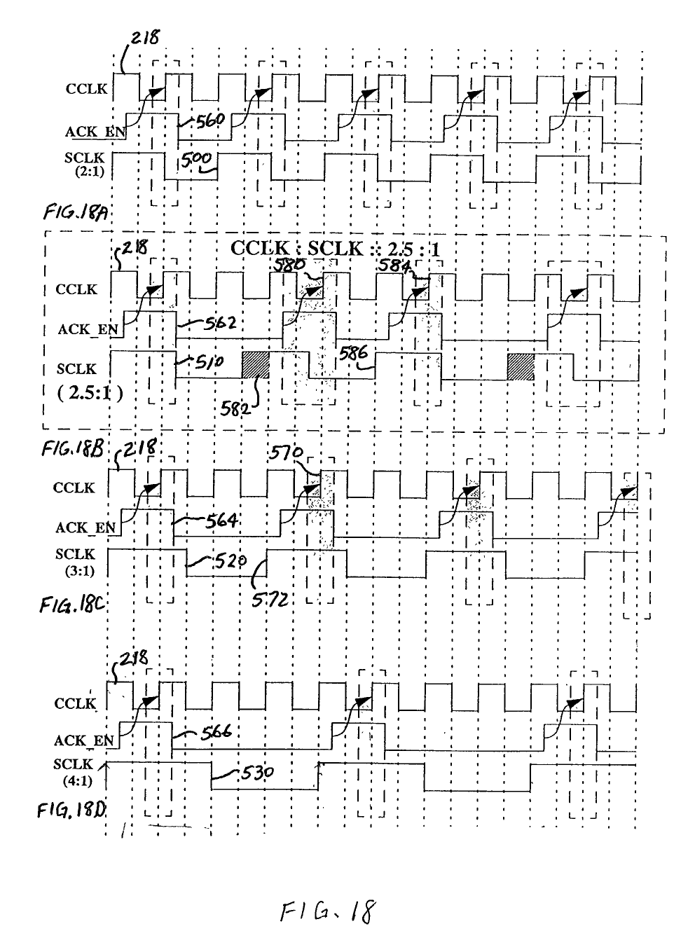

Signals associated with conversion from the system clock domain to the core clock domain are shown in FIGS. 18A-18D for different clock ratios. ACK_EN synchronization signals 560, 562, 564 and 566 are used to synchronize transfers from the system clock domain to the core clock domain for clock ratios of 2:1, 2.5:1, 3:1 and 4:1, respectively. Each ACK_EN synchronization signal has the same frequency as the system clock and is asserted (logic high in this example) for one core clock cycle per system clock cycle. The ACK_EN synchronization signal is phased such that a core clock rising edge that occurs when the ACK_EN synchronization signal is asserted is the first rising edge of the core clock following a rising edge of the system clock. Thus, for example, with reference to FIG. 18C, rising edge 570 of core clock 218 is the first rising edge that follows rising edge 572 of system clock 520. Signals are transferred from the system clock domain to the core clock domain on the rising edge 570 of core clock 218.

In the case of a non-integer clock ratio, as illustrated in FIG. 18B, every other system clock cycle is effectively reduced by ½ core clock cycle. Thus, rising edge 580 of core clock 218 is the first rising edge of core clock 218 that occurs when the ACK_EN synchronization signal is enabled. This effectively reduces the system clock 510 by ½ core clock cycle as indicated by shaded area 582. Alternate system clock cycles operate in the same manner as the integer clock ratio case. Thus, for example, rising edge 584 of core clock 218 is the first rising edge after rising edge 586 of system clock 510. Rising edge 584 occurs when the ACK_EN synchronization signal is asserted.

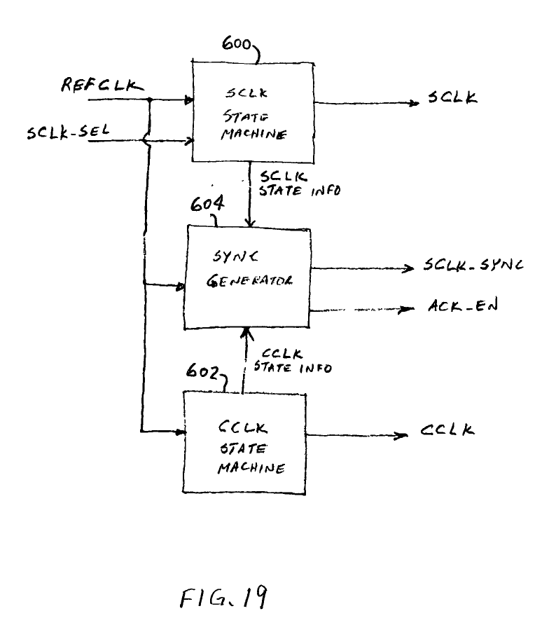

Circuitry for generating the core clock and the system clock with a selectable clock ratio and for generating the SCLK_SYNC and ACK_EN synchronization signals is shown in FIG. 19. A reference clock, REFCLK, is supplied to a system clock state machine 600, a core clock state machine 602 and a sync generator 604. The circuitry shown in FIG. 19 may be incorporated into the SL2 bus controller 156 shown in FIG. 14 and described above. The reference clock has a frequency of two times the desired core clock frequency in this example. A ratio select signal, SCLK_SEL, selects a desired clock ratio of the core clock frequency to the system clock frequency. As noted above, clock ratios of 2:1, 2.5:1, 3:1 and 4:1 may be selected in the present example. The system clock state machine 600 divides the reference clock frequency in accordance with the selected clock ratio to produce the system clock. The core clock state machine 602 divides the reference clock by 2 to produce the core clock. The sync generator 604 receives the reference clock and state information from the system clock state machine 600 and the core clock state machine 602 to produce the SCLK_SYNC synchronization signal as shown in FIGS. 17A-17D and to produce the ACK_EN synchronization signal as shown in FIGS. 18A-18D.

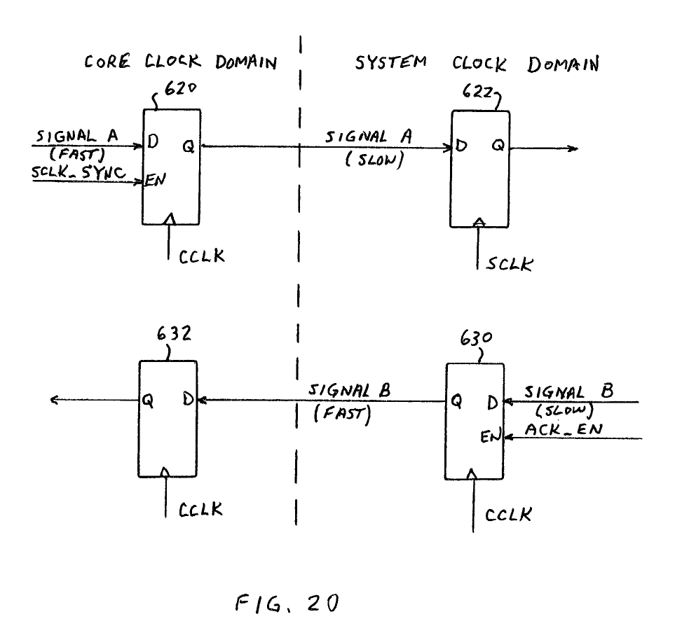

The transfer of signals between clock domains using the synchronization signals described above is illustrated in FIG. 20. A digital signal A is transferred from the core clock domain to the system clock domain by a flip-flop 620. Signal A is applied to the D input of flip-flop 620, the SCLK_SYNC synchronization signal is applied to the enable input of flip-flop 620 and the core clock is applied to the clock input of flip-flop 620. The output of flip-flop 620 is synchronous with the system clock domain. Using the example of FIG. 17C, the synchronization signal 522 enables flip-flop 620 and signal A is transferred to the output of flip-flop 620 on rising edge 540 of core clock 218. As illustrated in FIG. 17C, rising edge 540 of core clock 218 is synchronous with the rising edge 542 of system clock 520. Thus, the output of flip-flop 620 is synchronous with the system clock domain and may be applied to a flip-flop 622, for example, which is clocked by the system clock.

A digital signal B may be transferred from the system clock domain to the core clock domain using a flip-flop 630. Signal B is applied to the D input of flip-flop 630, the ACK_EN synchronization signal is applied to the enable input of flip-flop 630 and the core clock is applied to the clock input of flip-flop 630. The output of flip-flop 630 is synchronous with the core clock domain. Using the example of FIG. 18C, flip-flop 630 is enabled by synchronization signal 564 and signal B is transferred to the output of flip-flop 630 on the rising edge 570 of core clock 218. Rising edge 570 of core clock 218 is the first rising edge that occurs after rising edge 572 of system clock 520. Signal B is present at the input of flip-flop 630 following rising edge 572 of system clock 520. The output of flip-flop 630 is synchronous with the core clock domain and may, for example, be applied to the D input of a flip-flop 632, which is clocked by the core clock.

While there have been shown and described what are at present considered the preferred embodiments of the present invention, it will be obvious to those skilled in the art that various changes and modifications may be made therein without departing from the scope of the invention as defined by the appended claims.

What is claimed:

1. A digital signal processor comprising:
a core processor for executing instructions;
a memory having a memory bus for transfer of data; and
a bus controller for directing transfer requests from said core processor to said memory, said bus controller, said memory bus and said memory having a pipeline for transferring data between said core processor and said memory, said pipeline having a number of pipeline stages that is equal to or greater than a latency of a read transfer request in clock cycles.

2. A digital signal processor as defined in claim 1, wherein said pipeline includes six pipeline stages.

3. A digital signal processor as defined in claim 1, wherein said bus controller is configured to complete one read transfer request per clock cycle after an initial latency.

4. A digital signal processor as defined in claim 1, wherein said bus controller is configured to service transfer requests on two processor data buses and one processor instruction bus.

5. A digital signal processor as defined in claim 4, wherein said bus controller includes an arbiter for servicing processor transfer requests according to an assigned priority.

6. A digital signal processor as defined in claim 1, wherein said core processor includes two or more processor buses and wherein said bus controller, said memory bus and said memory are configured to service processor transfer requests on said two or more processor buses without stalling the pipeline between the processor transfer requests.

7. A digital signal processor as defined in claim 1, wherein said bus controller is configured for processing single word transfer requests and burst mode transfer requests.

8. In a digital signal processor including a core processor, a memory and two or more system buses for transfer of data to and from system components, a bus interface unit comprising:
a first bus controller for receiving processor transfer requests from the core processor on two or more processor buses and for directing the processor transfer requests to the memory on a first memory bus; and
a second bus controller for receiving system transfer requests from the system components on the two or more system buses and for directing the system transfer requests to the memory on a second memory bus.

9. A bus interface unit as defined in claim 8, wherein said first bus controller and said second bus controller are configured to simultaneously direct processor transfer requests and system transfer requests to the memory on the first memory bus and the second memory bus, respectively.

10. A bus interface unit as defined in claim 8, wherein each of said first bus controller and said second bus controller has a pipeline.

11. A bus interface unit as defined in claim 10, wherein said first bus controller is configured to complete one read transfer request per clock cycle after an initial latency.

12. A bus interface unit as defined in claim 10, wherein said first bus controller is configured to direct to the memory, on the first memory bus, processor transfer requests from two processor data buses and one processor instruction bus.

13. A bus interface unit as defined in claim 10, wherein said first bus controller includes an arbiter for directing the processor transfer requests to the memory according to an assigned priority.

14. A bus interface unit as defined in claim 10, wherein said second bus controller includes an arbiter for directing the system transfer requests to the memory according to an assigned priority.

15. A bus interface unit as defined in claim 10, wherein said first bus controller and said first memory bus are configured to service processor transfer requests on said two or more processor buses without stalling the pipeline between the processor transfer requests.

16. A bus interface unit as defined in claim 10, wherein said second bus controller and said second memory bus are configured to service system transfer requests on said two or more systems buses without stalling the pipeline between the system transfer requests.

17. A bus interface unit as defined in claim 8, wherein the first memory bus and the second memory bus operate at a core clock frequency and the system buses operate at a system clock frequency that is lower than the core clock frequency.

18. A bus interface unit as defined in claim 17, wherein said second memory bus controller includes clock conversion circuitry for converting to and between the core clock frequency and the system clock frequency.

19. A bus interface unit as defined in claim 8, wherein each of said first bus controller and said second bus controller is configured for processing single word transfer requests and burst mode transfer requests.

20. A bus interface unit as defined in claim 10, wherein said first bus controller and said second bus controller are configured to service transfer requests independently.

21. A digital signal processor comprising:
a core processor for executing instructions, said core processor having two or more processor buses for transfer of data;
a memory having a first memory bus and a second memory bus;
two or more system buses for transfer of data to and from system components; and
a bus interface unit including a first bus controller for directing processor transfer requests on said two or more processor buses to said first memory bus and a second bus controller for directing system transfer requests on said two or more system buses to said second memory bus.

22. A digital signal processor as defined in claim 21, wherein said memory includes two or more independently-accessible memory banks, wherein transfer requests on said first memory bus and said second memory bus can be serviced simultaneously when different memory banks are accessed.

23. A digital signal processor as defined in claim 22, wherein said first bus controller and said second bus controller each have a pipeline.

24. A digital signal processor as defined in claim 23, wherein said first bus controller is configured to complete one read transfer request per clock cycle after an initial latency.

25. A digital signal processor as defined in claim 23, wherein said pipeline has a number of pipeline stages that is equal to or greater than a latency of a read transfer request in clock cycles.

26. A digital signal processor as defined in claim 23, wherein said pipeline includes six pipeline stages.

27. A digital signal processor as defined in claim 23, wherein said first bus controller is configured to service transfer requests on two processor data buses and one processor instruction bus.

28. A digital signal processor as defined in claim 23, wherein said first bus controller and said first memory bus are configured to service processor transfer requests on said two or more processor buses without stalling the pipeline between the processor transfer requests.

29. A digital signal processor as defined in claim 23, wherein said second bus controller and said second memory bus are configured to service system transfer requests on said two or more systems buses without stalling the pipeline between the system transfer requests.

30. A digital signal processor as defined in claim 21, wherein said first bus controller includes an arbiter for servicing processor transfer requests according to an assigned priority.

31. A digital signal processor as defined in claim 21, wherein said second bus controller includes an arbiter for servicing system transfer requests according to an assigned priority.

32. A digital signal processor as defined in claim 21, wherein the first memory bus and the second memory bus operate at a core clock frequency and wherein the two or more system buses operate at a system clock frequency that is lower than the core clock frequency.

33. A digital signal processor as defined in claim 32, wherein said second bus controller includes a clock conversion circuit for converting to and between the core clock frequency and the system clock frequency.

34. A digital signal processor as defined in claim 21, wherein each of said first bus controller and said second bus controller is configured for processing single word transfer requests and burst mode transfer requests.

35. A digital signal processor as defined in claim 21, wherein said first bus controller and said second bus controller service memory transfer requests independently.

36. A digital signal processor as defined in claim 21, wherein said bus interface unit further includes a power-saving circuit for supplying a power save signal to said memory when transfer requests are not being serviced.

37. In a digital signal processor including a core processor, a memory and two or more system buses for transfer of data to and from system components, a method for accessing the memory comprising:
receiving processor transfer requests from the core processor on two or more processor buses and directing the processor transfer requests to the memory on a first memory bus; and
receiving system transfer requests from the system components on the two or more system buses and directing the system transfer requests to the memory on a second memory bus.

38. A method as defined in claim 37, wherein receiving and directing the processor transfer requests and receiving and directing the system transfer requests comprises simultaneously directing processor transfer requests and system transfer requests to the memory on the first memory bus and the second memory bus, respectively.

39. A method as defined in claim 37, wherein receiving and directing the processor transfer requests comprises completing one transfer request per clock cycle after an initial latency.

40. A method as defined in claim 37, wherein receiving and directing the processor transfer requests comprises directing the processor transfer requests to the memory according to an assigned priority.

41. In a digital signal processor including a core processor, a memory and two or more system buses for transfer of data to and from system components, a bus interface unit comprising:
means for receiving processor transfer requests from the core processor on two or more processor buses and directing the processor transfer requests to the memory on a first memory bus; and
means for receiving system transfer requests from the system components on the two or more system buses and directing the system transfer requests to the memory on a second memory bus.

42. A bus interface unit as defined in claim 41, wherein said means for receiving and directing the processor transfer requests and said means for receiving and directing the system transfer requests comprises means for simultaneously directing processor transfer requests and system transfer requests to the memory on the first memory bus and the second memory bus, respectively.

43. A bus interface unit as defined in claim 41, wherein said means for receiving and directing the processor transfer requests comprises means for completing one read transfer request per clock cycle after an initial latency.

44. A bus interface unit as defined in claim 41, wherein said means for receiving and directing the processor transfer requests and said means for receiving and directing the system transfer requests each has a pipeline.

45. A bus interface unit as defined in claim 44, wherein said means for receiving and directing the processor transfer requests and the first memory bus are configured to service processor transfer requests on said two or more processor buses without stalling the pipeline between the processor transfer requests.

46. A bus interface unit as defined in claim 44, wherein said means for receiving and directing the system transfer requests and the second memory bus are configured to service system transfer requests on said two or more system buses without stalling pipeline between the system transfer requests.

47. A bus interface unit as defined in claim 41, wherein said means for receiving and directing the processor transfer requests comprises means for directing the processor transfer requests to the memory according to an assigned priority.

48. A memory system comprising:
a memory;
a memory bus coupled to said memory; and
a bus controller for directing transfer requests to said memory on said memory bus, said bus controller, said memory bus and said memory having a pipeline for supplying data in response to said transfer requests, said pipeline having a pipeline depth that is equal to or greater than a memory latency in clock cycles.
